(19) United States
(12) Patent Application Publication
(10) Pub. No.: US 2007/0169461 A1
(43) Pub. Date: Jul. 26, 2007

(54) CATALYTIC BIPROPELLANT HOT GAS GENERATION SYSTEM

(75) Inventor: Mike S. Koerner, Rancho Palos Verdes, CA (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., MORRISTOWN, NJ (US)

(21) Appl. No.: 11/381,572

(22) Filed: May 4, 2006

Related U.S. Application Data
(60) Provisional application No. 60/760,778, filed on Jan. 19, 2006.

(51) Int. Cl. F02G 3/00

(52) U.S. Cl. 60/39.12

(57) ABSTRACT

A bipropellant gas generation system comprises a fuel storage assembly, a diluted oxidizer storage assembly and a reaction assembly. The diluted oxidizer storage assembly includes a mixture of an oxidant and a diluent, such as nitrogen or an inert gas. The fuel and the diluted oxidizer are mixed together and reacted within the reaction assembly. The resulting reaction gas is cooled by the diluent, allowing the gas generation system to be operated at a stoichiometric oxidant-to-fuel ratio.

### CROSS-REFERENCE TO RELATED APPLICATION

This application claims the benefit of U.S. Provisional Application Ser. No. 60/760,778, which was filed on Jan. 19, 2006, and is incorporated herein by reference.

### GOVERNMENT INTERESTS

The invention was made with Government support under contract number GH1-259333 awarded by NASA through Lockheed Martin. The Government has certain rights in this invention.

### BACKGROUND OF THE INVENTION

The present invention generally relates to gas generation systems and, more particularly, to catalytic bipropellant hot gas generation systems.

Generally, a gas generation system may include a fuel and an oxidizer. The fuel and the oxidizer may be mixed together and reacted. The exothermic reaction between the fuel and the oxidizer can provide a supply of gas.

Gas generation systems, such as bipropellant gas generators, are used in a wide range of aviation and space applications. Many of these applications, particularly ones where the gases are to be used to drive a turbine wheel, have temperature limitations that apply to the products of the reaction. For auxiliary and emergency power generation systems for example, it is common for the turbine inlet temperature to be limited to something less than 2000 degrees F., depending on the materials used for the turbine and turbine housing, and the turbine tip speed.

Most oxidizer and fuel combinations, if reacted stoichiometrically (such that all the oxidant is consumed and all the fuel is oxidized), burn too hot for turbine applications. Thus gas generators used in these applications typically operate at either a higher than stoichiometric oxidizer-to-fuel (O/F) ratio or at a lower than stoichiometric O/F ratio. In the first case excess oxidizer is used to cool the reaction products while in the second case excess fuel is used.

The choice of whether to operate fuel-lean (high O/F) or fuel-rich (low O/F) is usually based on minimizing overall system size and weight, taking into account other gas properties which effect turbine performance such as molecular weight and the ratio of specific heats (Cp/Cv), the total weight and volume of propellants needed, and the weight of the storage vessels necessary to contain the propellants. Safety considerations may also affect the choice between fuel-lean and fuel-rich operation as either the excess un-reacted oxidant or excess un-reacted fuel in the reaction gas stream may support subsequent unintended reactions. Often times this selection involves some degree of compromise, as neither approach is truly optimal.

An alternative is to combine the fuel and oxidant stoichiometrically while adding a third constituent, such as an inert gas or liquid, to cool the evolved gases. The problem with this approach is that it requires a third supply system, including tankage and control valves, and an additional set of injectors to mix the cooling fluid with the reaction products.

Another alternative is to combine all three constituents—oxidant, fuel and diluent for cooling—and store them that way, as is typically done with solid propellants and monopropellants. A unique example of a monopropellant combination of gases is described in U.S. Pat. No. 3,779,009. But monopropellants by their very nature are more dangerous to handle than separate fuels and oxidizers.

Monopropellant and bipropellant systems have been disclosed in U.S. Pat. No. 5,779,266. A gas generation system for inflating a vehicle inflatable device is described. The disclosed gas generator includes two chambers. In the first chamber, a pyrotechnic device is used to ignite a fuel and an oxidant. The resulting combustion gases are expelled into the second chamber, which contains a supply of pressurized stored gas. The combustion gases mix with the pressurized stored gas to provide inflation gas for the vehicle inflatable device. To reduce high flame temperatures the oxidant of the '266 patent can be diluted with an inert gas, forming “enriched-oxygen” mixtures (greater than 21% oxygen). For example, an oxidant mixture of 50-65% vol. oxygen with the balance being argon was described as being advantageous when used with ethyl alcohol-based fuels. Although the “enriched-oxygen” mixtures may reduce flame temperatures and may be necessary to ensure the proper functioning of the pyrotechnic device, the “enriched-oxygen” mixtures present handling and safety problems. Additionally, greater temperature reductions are needed for some turbine applications.

Further, the '266 assembly is described as being operated with equivalence ratios “preferably in the range of 0.5≦φ≦0.8”, with equivalence ratio (φ) being defined as the ratio of the actual fuel to oxidant ratio (F/O)A. divided by the stoichiometric fuel to oxidant ratio (F/O)s. (Note: In other literature, equivalence ratio (φ) has been defined as the ratio of the actual oxidant to fuel ratio (O/F)A. divided by the stoichiometric oxidant to fuel ratio (O/F)s). Although the preferred fuel-lean operation of the '266 system may provide some benefits, fuel-lean operation can decrease system efficiency for some applications and may negatively impact system safety by producing an oxidizing reaction gas stream.

As can be seen, there is a need for improved gas generation systems. Additionally, there is a need for gas generators that provide reaction product temperature reductions while operating at a stoichiometric O/F ratio. Further, smaller, lighter weight systems are needed wherein the reaction products can be cooled without the need for additional tankage. Moreover, safer gas generation systems are needed. Further, gas generation systems are needed wherein reaction product temperatures are reduced without the need to operate fuel-lean or fuel-rich.

### SUMMARY OF THE INVENTION

In one aspect of the present invention, a system comprises a reaction assembly; a diluted oxidizer storage assembly in flow communication with the reaction assembly, the diluted oxidizer storage assembly including a supply of diluted oxidizer; and a fuel storage assembly in flow communication with the reaction assembly, the fuel storage assembly including a supply of fuel.

In another aspect of the present invention, a system comprises a reaction assembly having a mixing chamber; at least one fuel injector operationally connected to the mixing chamber; a fuel storage assembly in flow communication with the at least one fuel injector, the fuel storage assembly including a supply of fuel; at least one diluted oxidizer injector operationally connected to the mixing chamber; and a diluted oxidizer storage assembly in flow communication with the at least one diluted oxidizer injector, the diluted oxidizer storage assembly including a supply of diluted oxidizer, the diluted oxidizer comprising an oxidant and a diluent.

In still another aspect of the present invention, a system comprises a reaction assembly having a catalyst bed; a diluted oxidizer storage assembly in flow communication with the reaction assembly, the diluted oxidizer storage assembly including an oxidant and a diluent; and a fuel storage assembly in flow communication with the reaction assembly, the fuel storage assembly including a supply of pressurized gas fuel.

These and other features, aspects and advantages of the present invention will become better understood with reference to the following drawings, description and claims.

### BRIEF DESCRIPTION OF THE DRAWINGS

FIG. 1 is a schematic diagram of a gas generation system according to one embodiment of the present invention;

FIG. 2 is a graph of total system weight and volume verses propellant composition according to an embodiment of the present invention; and

FIG. 3 is a flow chart of a method of producing a supply of gas according to an embodiment of the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Broadly, the present invention provides gas generation systems and methods for producing a gas. Embodiments of the present invention may find beneficial use in many industries including aviation, space and automotive. Embodiments of the present invention may be beneficial in applications including emergency power systems and emergency restart systems for aircraft and turbine power system on launch vehicles and spacecraft. Embodiments of this invention may be useful in any gas generation application.

In one embodiment, the present invention may combine an inert gas or other diluent with an oxidant to form a diluted oxidizer in a bipropellant system. Unlike the prior art systems that combine the fuel and oxidant stoichiometrically while adding a third constituent to the evolved gases, the present invention does not require a third supply system, including tankage and control valves, nor an additional set of injectors to mix the cooling fluid with the reaction products. The diluted oxidizer of the present invention offers several other significant advantages over the prior art approaches. First, the formulation of the oxidant and the diluent in the diluted oxidizer can be tailored for a specific application. Second, by combining the diluent with the oxidant, the diluted oxidizer becomes much safer to store and handle.

Additionally, unlike the prior art systems that operate fuel-rich or fuel-lean and use excess fuel or excess oxidizer to cool the reaction products, the oxidant and the fuel of the present invention may be presented to the catalyst in a stoichiometric or near stoichiometric O/F ratio. This is the ratio that results in the maximum reaction temperature. This offers several advantages over the prior art fuel-rich and fuel-lean approaches. First, at this maximum temperature the slope of the temperature vs. O/F ratio curve is near zero. That means that small variations in the fuel flow rate, or in the diluted oxidizer flow rate, will have little effect on the reaction temperature. This is an advantage over prior art systems that operate fuel-rich or fuel-lean and as a result have reaction temperatures that are sensitive to the relative flow rates of the oxidizer and fuel. Second, the stoichiometric or near stoichiometric operation means that reaction process may be inherently “Fail-safe” in that even large variations in the propellant flow rates, such as might be caused by improper functioning of the control valves, can not produce unacceptably high reaction gas temperatures. This is unlike prior art fuel-rich systems using pure oxygen as the oxidizer for example, where a fuel valve that is slow to open, or the oxygen supply pressure which is a bit too high, can result in unacceptably high reaction gas temperatures. Third, since all, or nearly all, of the oxidant and fuel may be consumed in the reaction, the reaction products may be less reactive and thus safer than prior art fuel-lean systems which produce oxidizing gases and fuel-rich systems which produce reducing gases,

Further, unlike the prior art systems that use a pyrotechnic device to ignite a fuel and “enriched-oxygen” mixture, the present invention can use a catalyst to initiate the reaction of a fuel and essentially diluted air mixture. Whereas normal air is basically 80% nitrogen and 20% oxygen, the diluted oxidizer of the present invention may comprise 93% nitrogen and only 7% oxygen for some embodiments. It is often said that things which do not burn in air, burn in oxygen, and things which burn in air, explode in oxygen. By combining the diluent with the oxidant, the diluted oxidizer becomes much safer to store and handle when compared with the oxidant alone or with the “enriched-oxygen” mixtures.

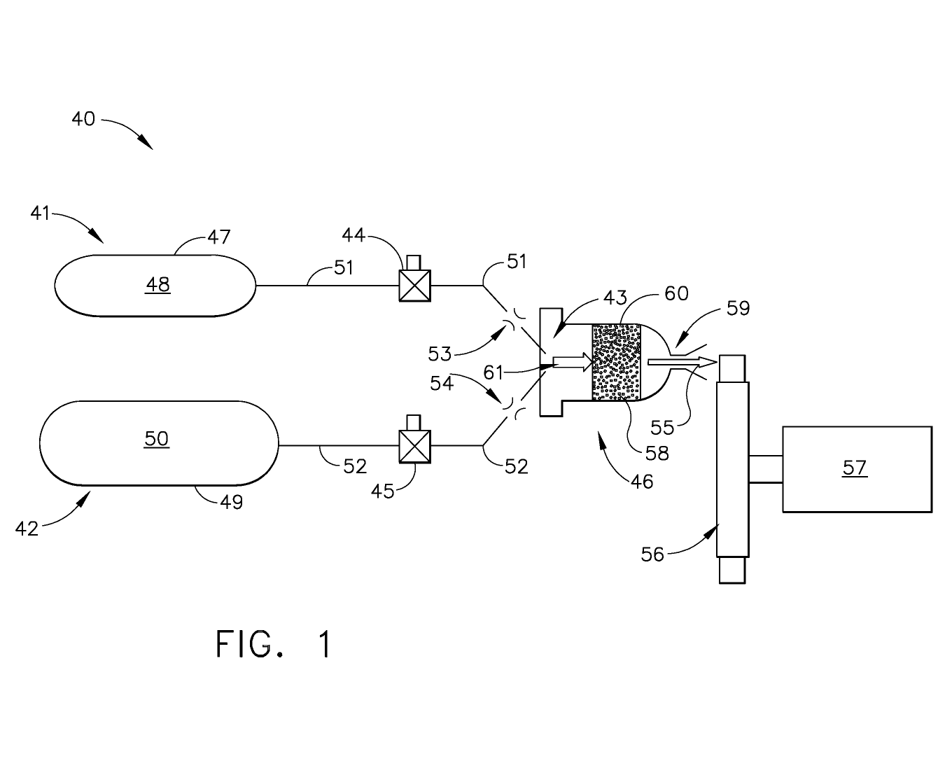

A gas generation system 40 according to an embodiment of the present invention is depicted in FIG. 1. The system 40 may comprise a fuel storage assembly 41, a diluted oxidizer storage assembly 42, and a reaction assembly 46. The fuel storage assembly 41 may include a supply of fuel (not shown) and may be in flow communication with the reaction assembly 46. The diluted oxidizer storage assembly 42 may include a supply of diluted oxidizer (not shown) and may be in flow communication with the reaction assembly 46. The fuel and the diluted oxidizer may flow from their respective storage assemblies 41,42 and into the reaction assembly 46. The propellants (the fuel and the diluted oxidizer) may collide and mix together within the reaction assembly 46. An exothermic reaction between the propellants may provide a supply of reaction gas 55. In some embodiments, a turbine 56, positioned downstream from the reaction assembly 46, may extract energy from the reaction gas 55 and transfer the energy to a load 57, such as an engine shaft.

The fuel storage assembly 41, as depicted in FIG. 1, may comprise a fuel storage member 47 having a fuel chamber 48. The supply of fuel may be positioned within the fuel chamber 48.

The fuel storage member 47 may comprise a composite, fiber-wound, high-pressure vessel. For some embodiments of the present invention, the fuel storage member 47 may comprise an aluminum liner wrapped with carbon fiber in an epoxy matrix. The aluminum liner may provide low permeability and the carbon fiber composite may provide strength. Other useful fibers may include fiberglass, which may offer higher toughness though at increased weight, and Kevlar fibers, which are between carbon and glass both in strength to weight ratio and in toughness. Titanium, steel and aluminum vessels can also be used, and though heavier, offer advantages in some applications. The fuel storage member 47 may comprise any structure that defines the fuel chamber 48 and is designed to store the supply of fuel.

The supply of fuel may include a pressurized gas fuel or a liquid fuel. For some embodiments of the present invention, the pressurized gas fuel may comprise pressurized hydrogen gas. For some embodiments of the present invention, the pressurized gas fuel may include other gaseous fuels such as light hydrocarbons. Useful light hydrocarbons may include methane, ethane, butane and propane. For some embodiments of the present invention, the pressurized gas fuel may include at least one of hydrogen, methane, ethane, butane and propane. For example, the pressurized gas fuel may comprise a mixture of methane and ethane. For some embodiments of the present invention, the liquid fuel may comprise liquid hydrogen, alcohols, hydrazine derivatives and heavier hydrocarbons such as gasoline, diesel, jet fuel or rocket propellant. For some applications, the liquid fuel may be vaporized or finely atomized to effectively mix with the diluted oxidizer in the reaction assembly 46. The composition of the fuel may depend on factors including the composition of the diluted oxidizer, the desired temperature of the reaction gas 55 and the application. For example, when the supply of diluted oxidizer comprises a pressurized oxygen/nitrogen gas mixture and the desired temperature of the reaction gas 55 is between about 1500° F. and about 1800° F., the supply of fuel may comprise pressurized hydrogen gas for some turbine applications.

For some applications, the pressurized gas fuel may be stored at 5000 psi to allow compact storage without excessive tank (fuel storage member 47) weight. In other applications lower pressures such as 2000 to 3000 psi may be used. Indeed, a full range of storage pressures may be possible, although pressures much higher than 5000 psi may suffer a penalty due to the compressibility of the gases. Further, pressures below 2000 psi may result in large storage volumes that may be less practical for some applications. Liquids may be expelled from the fuel storage member 47 with pressurized gas stored at lower pressures, such as 100 to 1000 psi.

The diluted oxidizer storage assembly 42, as depicted in FIG. 1, may comprise a diluted oxidizer storage member 49 having a diluted oxidizer chamber 50. The supply of diluted oxidizer may be positioned within the diluted oxidizer chamber 50.

The diluted oxidizer storage member 49 may comprise a composite, fiber-wound, high-pressure vessel. For some embodiments of the present invention, the diluted oxidant storage member 49 may comprise an aluminum liner wrapped with carbon fiber in an epoxy matrix. The aluminum liner may provide low permeability and the carbon fiber composite may provide strength. Other useful fibers may include fiberglass, which may offer higher toughness though at increased weight, and Kevlar fibers, which are between carbon and glass both in strength to weight ratio and in toughness. Titanium, steel and aluminum vessels can also be used, and though heavier, offer advantages in some applications. The diluted oxidizer storage member 49 may comprise any structure that defines the diluted oxidizer chamber 50 and is designed to store the supply of diluted oxidizer.

The supply of diluted oxidizer may comprise a mixture of an oxidant and a diluent. In one embodiment of the present invention, the supply of diluted oxidizer may comprise a mixture of a pressurized gas oxidant and a pressurized gas diluent (pressurized gas diluted oxidizer). Useful pressurized gas oxidants may include oxygen, nitrous oxide and fluorine. The pressurized gas oxidant can comprise a combination of one or mores gases. For example, the pressurized gas oxidant may comprise a mixture of oxygen and nitrous oxide. Useful pressurized gas diluents may include nitrogen and inert gases. Useful inert gases may include helium, neon, argon and krypton. The diluent can comprise a combination of one or mores gases. For example, the diluent may comprise a mixture of nitrogen and helium. In another embodiment of the present invention, the supply of diluted oxidizer may comprise a mixture of a liquid oxidant and a liquid diluent (liquid diluted oxidizer). When the oxidant comprises a liquid oxidant, more effective mixing of the oxidant and the diluent within the diluted oxidizer chamber 50 may be achieved by using a liquid diluent as opposed to a pressurized gas diluent. Useful liquid oxidants may include liquid oxygen, liquid fluorine, hydrogen peroxide, nitric acid and nitrogen tetroxide. For some embodiments of the present invention, the liquid oxidant may include at least one of liquid oxygen, liquid fluorine, hydrogen peroxide, nitric acid and nitrogen tetroxide. For example, the liquid oxidant may comprise a mixture of nitric acid and nitrogen tetroxide. Useful liquid diluents may include water. The liquid diluted oxidizer may be vaporized or finely atomized to effectively mix with the fuel in the reaction assembly 46.

For some applications, the pressurized gas diluted oxidizer may be stored at 5000 psi to allow compact storage without excessive tank (diluted oxidizer storage member 48) weight. In other applications lower pressures such as 2000 to 3000 psi may be used. Indeed, a full range of storage pressures may be possible, although pressures much higher than 5000 psi may suffer a penalty due the compressibility of the gases. Further, pressures below 2000 psi result in large storage volumes that may be less practical. Liquids may be expelled from the diluted oxidizer storage member 48 with pressurized gas stored at lower pressures, such as 100 to 1000 psi.

The relative quantities of the oxidant and the diluent in the diluted oxidizer may depend on the compositions of the oxidant, the diluent and the fuel and the desired reaction gas temperature. For example, with oxygen as the oxidant, nitrogen as the diluent and hydrogen as the fuel, a diluted oxidizer comprising nitrogen and oxygen mixed in a ratio (by mass) of about 14 to 1, may generate reaction gases at 1580° F. when reacted with hydrogen at a diluted oxidizer to fuel ratio (by mass) of about 120 to 1 (in other words, the final mixture constituents would include 1 part hydrogen, 8 parts oxygen and 112 parts nitrogen by weight). Alternately, the diluent to oxidant ratio might range from 12 to 1 by weight to achieve 1800° F. gas when the diluted oxidizer is mixed with fuel at a ratio of 103 to 1 (1 part hydrogen, 8 parts oxygen and 95 parts nitrogen), or even 9 to 1 by weight to achieve 2200° F. gas when the diluted oxidizer is mixed with fuel at a ratio of 80 to 1 (1 part hydrogen, 8 parts oxygen and 72 parts nitrogen), to 20 to 1 by weight to achieve 1200° F. gas when the oxidizer is mixed with fuel at a ratio of 169 to 1 (1 part hydrogen, 8 parts oxygen and 161 parts nitrogen). In other words, for some embodiments, the supply of diluted oxidizer can comprise nitrogen and oxygen mixed in a ratio (by mass) of between about 9 to 1 and about 20 to 1. Although the relative quantities of the oxidant and the diluent may vary, for some applications the diluted oxidizer may include less than about 20% vol. oxygen and at least about 80% vol. diluent.

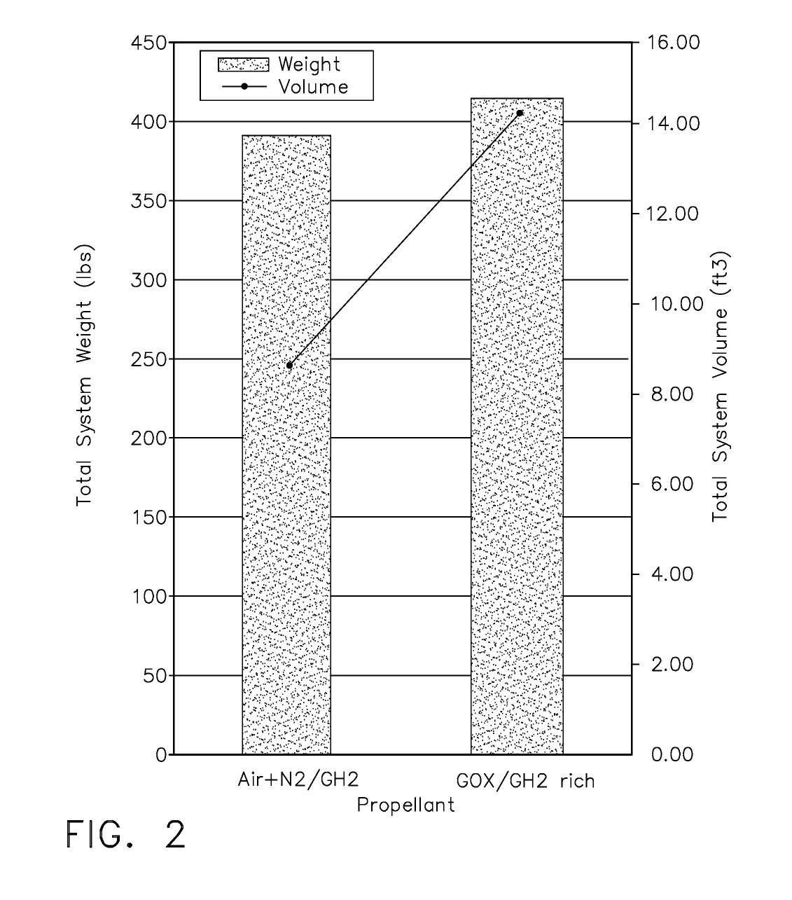

By varying the relative quantities of the oxidant and the diluent, the diluted oxidizer can be tailored for a specific application. The diluent may provide an added degree of freedom in optimizing the properties of the reaction products. As an example, consider the fuel-rich reaction of hydrogen and oxygen. An O/F ratio of 0.84 may give a 1580 degree F. reaction temperature, which is compatible with some high-temperature turbine wheels. The hydrogen storage density is so low however, that the overall volume of the system can be quite large. In one specific application, for example, the volume of the system using oxygen and hydrogen gases as propellants was 15.06 cubic feet. The volume of the system can be substantially reduced by combining nitrogen gas as a diluent with the oxygen, such as to form a diluted oxidizer, for example, with a nitrogen-to-oxygen ratio of 14 to 1. If this diluted oxidizer is then reacted with hydrogen at an O/F ratio of 120, the gas temperature may still be 1580° F., but because nitrogen can be stored more densely than hydrogen, the volume of the system in the above example will be reduced to 8.67 cubic feet, 58% from the previous size, as depicted in FIG. 2. Further, the over all weight of the proposed system, with its diluted oxidizer, was reduced by 9% from 426 to 388 lbs.

Additionally, the diluted oxidizer of the present invention can render the reaction itself “fail-safe”. With the above prior art fuel-rich system using pure oxygen as the oxidizer, if the hydrogen control valve was slow to open, or the oxygen control valve was slow to close, the resulting transient could result in the stoichiometric reaction of oxygen and hydrogen. At 5700 degrees F., even short-duration transients at stoichiometric conditions cause significant damage.

Another advantage of the gas generation system 40 is that the reaction gas 55 of the present invention may be safer than the prior art reaction gases. In the above example, depicted in FIG. 2, the principal constituent of the prior art reaction products is hydrogen gas. There is some potential for this hot exhaust gas to react with oxygen in the air as it is expelled from the system. If it is not hot enough to ignite at the exhaust exit, then there is some potential for it to mix with air, collect and subsequently ignite by some other source if the system is operated while the vehicle is not in motion. Further, the hot hydrogen gas tends to degrade many of the materials it comes in contact with by the process of hydrogen embrittlement. In contrast, the primary constituent of the reaction products (reaction gas 55) with the present invention may be nitrogen, which is not as reactive. In fact, there may be very little free oxygen or free hydrogen in the reaction gas 55.

The reaction assembly 46 itself may be either a catalytic reaction chamber, as depicted in FIG. 1, or a combustor; the primary difference being the means of initiating and maintaining the reaction. Catalysts may offer an advantage over combustors in being able to react combinations of diluted oxidizers and fuels which are outside the flamable range.

In the case of the catalytic reaction chamber, the reaction may be maintained, or at least initiated, by a catalyst 58. The catalytic reaction chamber, as depicted in FIG. 1, may comprise a mixing chamber 43 upstream of a catalyst bed 60 and a reaction gas exit 59 downstream of the catalyst bed 60. The catalyst bed 60 may include a catalyst 58 comprised of a platinum group metal, or comprised of finely dispersed particles of a platinum group metal on a pourus substrate. An example of such a catalyst, prominently known in the industry, is Honeywell 405 catalyst, which is comprised of finely dispersed iridium metal particles on a highly-porous, aluminum-oxide substrate. The catalyst 58 may include other catalytic materials, such as gold, silver, mercury, palladium and rhodium. In the case of the combustor, the heat of the reaction products may maintain the reaction thermally. The reaction in the combustor can be initiated either by a spark ignition system or hypergolically by contact between the fuel and the diluted oxidizer, if the diluted oxidizer and the fuel selected can be made to react hypergolically. A spark-initiated combustor rather than a catalytically-initiated reaction chamber may be useful for systems comprising a liquid fuel and/or a liquid diluted oxidizer.

When the reaction assembly 46 comprises a catalytic reaction chamber, which may depend on mixing the diluted oxidizer with the fuel upstream of the catalyst 58, with the prior art propellants any shortcomings in the mixing process can result in local areas with a high O/F ratio. These areas may result in hot spots that can damage the reactor components and degrade the catalyst life. In contrast, with embodiments of the present invention which present the oxidant and fuel to the catalyst 58 at a stoichiometric ratio, only the fully-mixed oxidizer and fuel can achieve the desired reaction temperature. Other areas, whether at higher or lower O/F ratios, will be cooler. Further, for these embodiments small variations in the fuel flow rate, or in the diluted oxidizer flow rate, may have little effect on the temperature of the reaction gas 55.

Alternately, for some embodiments, it may be desirable to purposely operate the system 40 either on the fuel-rich or fuel-lean side of the stoichiometric ratio. In this case the reaction temperature would be sensitive to variations in the flow rate of the reactant that is under-represented but relatively insensitive to variations in the flow rate of the other.

In addition to the fuel storage assembly 41, the diluted oxidizer assembly 42 and the reaction assembly 46, the gas generation system 40 may comprise one or more additional components. The system 40 may include a fuel supply line 51 positioned between and coupled to the fuel storage assembly 41 and the reaction assembly 46, as depicted in FIG. 1. The system 40 may include a diluted oxidizer supply line 52 positioned between and coupled to the diluted oxidizer assembly 42 and the reaction assembly 46. The supply lines 51, 52 each may comprise a length of tubing or piping.

Embodiments of the system 40 further may include at least one fuel injector 53 and at least one diluted oxidizer injector 54. The fuel injector 53 may be operationally connected to the fuel supply line 51 and may be designed to inject the fuel into the reaction assembly 46. The diluted oxidizer injector 54 may be operationally connected to the diluted oxidizer supply line 52 may be designed to inject the diluted oxidizer into the reaction assembly 46. The injectors 53, 54 may be designed to direct the propellants (the fuel and the diluted oxidizer) to collide and mix together within the reaction assembly 46.

Embodiments of the system 40 further may include a fuel control valve 44 and a diluted oxidizer control valve 45, as depicted in FIG. 1. The fuel control valve 44 may be operationally connected to the fuel supply line 51. The diluted oxidizer control valve 45 may be operationally connected to the diluted oxidizer supply line 52. The control valves 44, 45 may be used to maintain the ratio of fuel and diluted oxidizer in the reaction assembly 46. The control valves 44, 45 each may be a solenoid-actuated or squib-fired, open-or-closed shutoff valve with fixed downstream orifices. Alternatively, in lieu of the control valves 44, 45, the injectors 53, 54 may be used to maintain the ratio of fuel and oxidizer in the reaction assembly 46.

In some embodiments, it may be beneficial to also include pressure regulators (not shown) in the propellant supply lines 51, 52 either upstream or downstream of the control valves 44, 45, so that the flow rates, and thus the system power levels, remain fairly constant as the pressure in the storage assemblies 41, 42 decays. Another alternative is to include modulating, proportional-type valves (not shown) in either or both the propellant supply lines 51, 52, either along with the regulators and shutoff valves or instead of either or both. The proportional valves may allow the propellant flow rates, and thus power levels, to be adjusted, or in the case of a single proportional valve, allows the O/F ratio to be varied, or to be maintained despite variations in the flow rate of one of the propellants.

During operation of an embodiment of the present invention, the injectors 53, 54 may direct the diluted oxidizer and the fuel into the mixing chamber 43 on the up-stream end of the reaction assembly 46 at such a velocity and impingement angle as to promote mixing between the two gases (diluted oxidizer and fuel). The mixing of the two gases may provide a supply of mixed propellant gases 61, as depicted in FIG. 1. For some embodiments, it may also be desirable to have the injectors 53, 54 integrated into a cover (or head as it is most commonly known) (not shown) of the reaction assembly 46. Further, it may be desirable to have multiple fuel injectors 53 or diluted oxidizer injectors 54 located about the head to help promote the mixing of the gases. Alternately, if a liquid propellant is used, the injectors 53, 54 may be used to atomize the liquid.

The mixed propellant gases 61 then may pass through the catalyst bed 60 comprising the catalyst 58. The catalyst 58 may cause the mixed propellant gases 61 to react and in the process release heat, thus generating hot reaction products (reaction gas 55). Alternately, the spark ignition system may be used to initiate a thermal reaction for gas generation systems 40 including combustors.

For some applications wherein the reaction gas 55 is used to drive a turbine that is made of a high-temperature alloy such as Allvac Astroloy™ available from Allegheny Technologies (Monroe, N.C.), the temperature of the reaction gas 55 may be between about 1500° F. and about 1800° F. Alternately if the turbine comprises titanium, the temperature of the reaction gas 55 may be about 1200° F. Further, in applications that use ceramic turbine wheels, reaction gas temperatures of 2200° F. and higher may be practical. Still hotter temperatures can be used in applications where the reaction gas 55 is used directly to produce thrust, such as for rocket motors.

For some applications, the reaction gas 55 may be directed into a collection of converging-diverging nozzles (not shown), which would accelerate the reaction gas 55 to sonic velocities at the throat of the nozzles and further accelerate the reaction gas 55 as it expands to ambient pressure at the nozzle exits. The nozzles also may direct the reaction gas 55 toward the blades of an axial-impulse turbine wheel. Alternately, other turbine configurations can be used such as reaction-bladed turbine wheels. Further the reaction gas 55 may be used directly to produce thrust, to drive a pneumatic actuator, to heat something or for some other purpose.

For some applications, the rotational force generated by the impulse of the reaction gas 55 on the turbine blades could be used to drive some load such as a shaft-speed alternator or centrifugal pump. Alternately it may be used to directly drive some other load such as an actuator or in the case of an engine starter, to drive an engine. Further, the turbine output power may be used to drive a gearbox that could, in turn, drive a generator, piston pump or some other accessory load.

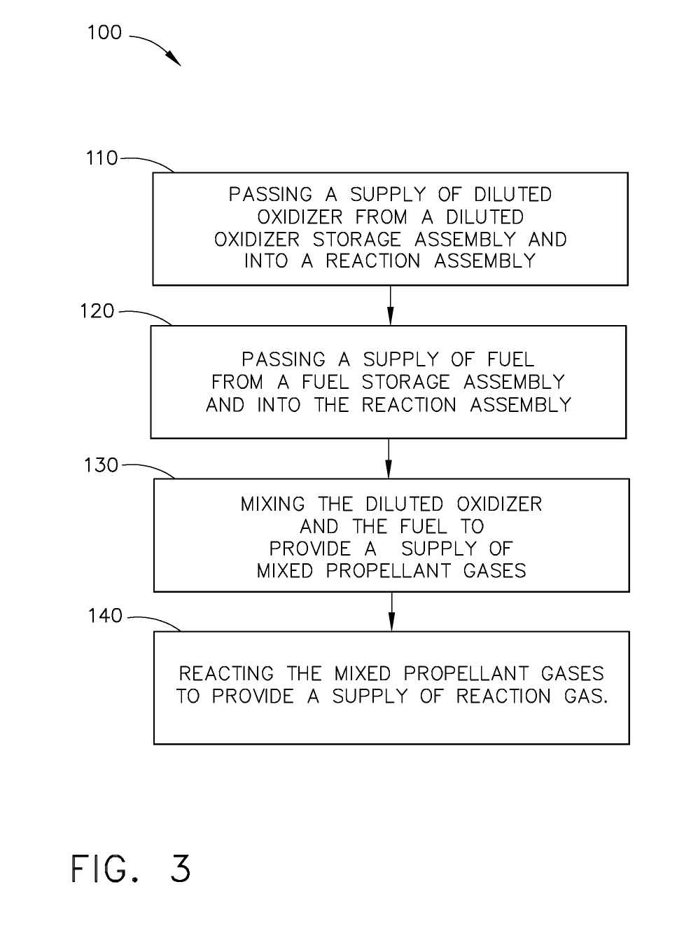

A method 100 of producing a supply of gas is depicted in FIG. 3. The method 100 may comprise a step 110 of passing a supply of diluted oxidizer from a diluted oxidizer storage assembly 42 and into a reaction assembly 46; a step 120 of passing a supply of fuel from a fuel storage assembly 41 and into the reaction assembly 46; a step 130 of mixing the diluted oxidizer and the fuel to provide a supply of mixed propellant gases 61; and a step 140 of reacting the mixed propellant gases 61 to provide a supply of reaction gas 55.

The step 110 of passing a supply of diluted oxidizer may comprise passing a supply of diluted oxidizer from a diluted oxidizer storage assembly 42 and into a catalytic reaction chamber. Alternatively, the step 110 of passing a supply of diluted oxidizer may comprise passing a supply of diluted oxidizer from a diluted oxidizer storage assembly 42 and into a combustor. The step 130 of mixing may comprise directing the diluted oxidizer and the fuel into a mixing chamber 43 on the up-stream end of the reaction assembly 46 at such a velocity and impingement angle as to promote mixing between the two gases. The step 140 of reacting the mixed propellant gases 61 may comprise passing the mixed propellant gases 61 through a catalyst bed 60. Alternatively, the step 140 of reacting the mixed propellant gases 61 may comprise initiating combustion using a spark ignition system. As another alternative, the step 140 of reacting the mixed propellant gases 61 may comprise initiating the reaction hypergolically.

As can be appreciated by those skilled in the art, embodiments of the present invention provide improved gas generation systems. The gas generation systems according to embodiments of the present invention can reduce reaction gas temperature without the need for a third supply system. Embodiments of the provided systems can reduce the overall volume and weight of the system, improving efficiency. Further, embodiments of the present invention provide gas generation systems wherein the oxidant and the fuel may be presented to the catalyst in a stoichiometric O/F ratio.

It should be understood, of course, that the foregoing relates to exemplary embodiments of the invention and that modifications may be made without departing from the spirit and scope of the invention as set forth in the following claims.

We claim:

1. A system comprising:
a reaction assembly;
a diluted oxidizer storage assembly in flow communication with said reaction assembly, said diluted oxidizer storage assembly including a supply of diluted oxidizer, said diluted oxidizer comprising at least about 80% vol. diluent; and
a fuel storage assembly in flow communication with said reaction assembly, said fuel storage assembly including a supply of fuel.

2. The system of claim 1, wherein said supply of diluted oxidizer comprises a mixture of a pressurized gas oxidant and a pressurized gas diluent.

3. The system of claim 1, wherein said supply of diluted oxidizer includes an oxidant selected from the group consisting of oxygen, nitrous oxide and fluorine.

4. The system of claim 1, further comprising:
a diluted oxidizer supply line positioned between and coupled to said diluted oxidizer storage assembly and said reaction assembly; and
at least one diluted oxidizer injector operationally connected to said diluted oxidizer supply line.

5. The system of claim 1, wherein said supply of diluted oxidizer comprises nitrogen and oxygen mixed in a ratio (by mass) of between about 9 to 1 and about 20 tol.

6. The system of claim 1, wherein said supply of diluted oxidizer comprises a liquid diluted oxidizer.

7. The system of claim 1, wherein said supply of fuel comprises at least one of hydrogen, methane, ethane, butane and propane.

8. The system of claim 1, wherein said supply of diluted oxidizer includes less than about 20% vol. oxygen.

9. The system of claim 1, wherein said supply of diluted oxidizer includes a diluent selected from the group consisting of nitrogen, helium, neon, argon and krypton.

10. The system of claim 1, wherein said reaction assembly includes a catalyst.

11. A system comprising:
a reaction assembly including a catalyst;
a fuel storage assembly in flow communication with said reaction assembly, said fuel storage assembly including a supply of fuel; and
a diluted oxidizer storage assembly in flow communication with said reaction assembly, said diluted oxidizer storage assembly including a supply of diluted oxidizer, said diluted oxidizer comprising an oxidant and a diluent.

12. The system of claim 11, wherein said reaction assembly includes a mixing chamber positioned upstream from said catalyst.

13. The system of claim 11, further comprising a turbine positioned downstream from said reaction assembly.

14. The system of claim 11, wherein said supply of fuel comprises at least one of hydrogen, methane, ethane, butane and propane.

15. The system of claim 11, wherein said oxidant comprises a pressurized gas oxidant and said diluent comprises a pressurized gas diluent.

16. The system of claim 11, further comprising a fuel supply line positioned between and coupled to said fuel storage assembly and said reaction assembly; and a fuel control valve operationally connected to said fuel supply line.

17. The system of claim 11, wherein said supply of fuel comprises a fuel selected from the group consisting of liquid hydrogen, alcohols, hydrazine derivatives, gasoline, diesel, jet fuel and rocket propellant.

18. The system of claim 11, wherein said diluent comprises water and said oxidant comprises at least one of liquid oxygen, liquid fluorine, hydrogen peroxide, nitric acid and nitrogen tetroxide.

19. The system of claim 11, further comprising:
at least one fuel injector operationally connected to said reaction assembly; and
at least one diluted oxidizer injector operationally connected to said reaction assembly.

20. A system comprising:
a reaction assembly;
a diluted oxidizer storage assembly in flow communication with said reaction assembly, said diluted oxidizer storage assembly including a supply of diluted oxidizer having an oxidant and a diluent; and
a fuel storage assembly in flow communication with said reaction assembly, said fuel storage assembly including a supply of fuel, said system designed to operate at a stoichiometric oxidant to fuel ratio.

21. The system of claim 20, wherein said supply of diluted oxidizer comprises at least about 80% vol. diluent.

22. The system of claim 20, wherein said reaction assembly comprises a catalyst bed.

23. The system of claim 20, wherein said oxidant comprises oxygen.

24. The system of claim 20, wherein said oxidant comprises a pressurized gas oxidant and said diluent comprises a pressurized gas diluent.

25. The system of claim 20, wherein said diluent includes nitrogen.
